(19) United States
(12) Patent Application Publication
(10) Pub. No.: US 2012/0314920 A1
(43) Pub. Date: Dec. 13, 2012

(54) METHOD AND DEVICE FOR ANALYZING HYPER-SPECTRAL IMAGES

(76) Inventors: Sylvain Prigent, Biot (FR); Xavier Descombes, Antibes (FR); Josiane Zerubia, Cannes La Bocca (FR); Didier Zugaj, Mougins-le-haut (FR); Laurent Petit, Peymeinade (FR)

(21) Appl. No.: 13/505,249

(22) PCT Filed: Oct. 28, 2010
(86) PCT No.: PCT/EP2010/066341

§ 371 Date: Aug. 16, 2012

Related U.S. Application Data
(60) Provisional application No. 61/323,008, filed on Apr. 12, 2010.
(60) Provisional application No. 61/305,383, filed on Feb. 17, 2010.

(30) Foreign Application Priority Data
Oct. 29, 2009 (FR) 0957625

(51) Int. Cl. G06K 9/78

(52) U.S. Cl. 382/128

(57) ABSTRACT

A device for analyzing a hyper-spectral image, comprising at least one sensor able to produce a series of images in at least two wavelengths, a calculation means able to class the pixels of an image according to a two-state classing relation, the image being received from a sensor, and a display means able to display at least one image resulting from the processing of the data received from the calculation means. The calculation means comprises: a means for determining training pixels receiving data from a sensor, a means for calculating a projection pursuit able to effect an automatic division of the spectrum of the hyper-spectral image, and a means for producing a large-margin separation. The calculation means is able to produce data in which the classed pixels are distinguishable.

### BACKGROUND OF THE INVENTION

1. Field of the Invention

The present invention relates to image analysis and more particularly the statistical classification of the pixels of an image. It relates more particularly to the statistical classification of the pixels of an image, with a view to detecting skin lesions, such as acne, melasma and rosacea.

2. Description of the Relevant Art

Chemical materials and elements react more or less differently when exposed to radiation of a given wavelength. By scanning the range of radiations, it is possible to differentiate materials involved in the composition of an object according to their difference of interaction. This principle can be generalized to a landscape, or to a part of an object.

The set of images resulting from the photograph of a same scene at different wavelengths is referred to as a hyper-spectral image or hyper-spectral cube.

A hyper-spectral image is made up of a set of images of which each pixel is characteristic of the intensity of the interaction of the observed scene with the radiation. By knowing the interaction profiles of materials with different radiations, it is possible to determine the materials present. The term material must be understood in a broad sense, covering not only solid, liquid and gaseous materials, but also pure chemical elements and complex assemblies of molecules or macromolecules.

The acquisition of hyper-spectral images can be effected according to a plurality of methods.

The method for acquiring hyper-spectral images known as a spectral scan consists in using a CCD sensor to produce spatial images and in applying different filters in front of the sensor in order to select a wavelength for each image. Different filter technologies enable the requirements of such imaging devices to be met. For example, one can cite liquid crystal filters which isolate a wavelength through electrical stimulation of the crystals, or acousto-optical filters which select a wavelength by deforming a prism due to a difference in electrical potential (piezo-electricity effect). These two filters offer the advantage that they do not have mobile parts, which are often a source of fragility in optical systems.

The method for acquiring hyper-spectral images referred to as a spatial scan aims to acquire or “to image” simultaneously all of the wavelengths of the spectrum on a CCD sensor. In order to implement the breakdown of the spectrum, a prism is placed in front of the sensor. A line-by-line spatial scan is then carried out in order to make up the complete hyper-spectral cube.

The method for acquiring hyper-spectral images referred to as a temporal scan consists in carrying out an interference measurement, then in reconstituting the spectrum by carrying out a Fast Fourier Transform (FFT) on the interference measurement. The interference is implemented using a Michelson system, which causes a beam to interfere with itself with a temporal offset.

The final method for acquiring hyper-spectral images aims to combine the spectral scan and the spatial scan. Thus, the CCD sensor is partitioned in the form of blocks. Each block therefore processes the same region of the space but with different wavelengths. A spectral and spatial scan then allows a complete hyper-spectral image to be constituted.

A plurality of methods exist for analyzing and classing hyper-spectral images obtained in this way, in particular for detecting lesions or diseases of a human tissue.

The document WO 99 44010 describes a method and device for hyper-spectral imaging for the characterization of a tissue of the skin. This document concerns the detection of a melanoma. This method is a method for characterizing the state of a region of interest of the skin, in which the absorption and diffusion of light in different frequency zones are a function of the state of the skin. This method comprises the generation of a digital image of the skin, including the region of interest in at least three spectral bands. This method implements a classification and a characterization of lesions. It comprises a segmentation step serving to implement a discrimination between lesions and normal tissue as a function of the different absorption of the lesions as a function of the wavelength, and an identification of the lesions through analysis of parameters such as texture, symmetry, or outline. Finally, the classification itself is implemented on the basis of a classification parameter L.

The document U.S. Pat. No. 5,782,770 describes a diagnostic device for cancerous tissues and a diagnostic method comprising the generation of a hyper-spectral image of a tissue sample and the comparison of this hyper-spectral image with a reference image in order to diagnose a cancer without introducing specific agents facilitating interaction with light sources.

The document WO 2008 103918 describes the use of imaging spectrometry to detect a cancer of the skin. It proposes a hyper-spectral imaging system allowing the fast acquisition of high-resolution images by avoiding the correction of images, problems of distortion of images or the movement of the mechanical components. It comprises a multi-spectral light source which illuminates the zone of the skin to be diagnosed, an image sensor, an optical system receiving the light from the skin zone and producing on an image sensor a mapping of the light delimiting the different regions, and a dispersion prism positioned between the image sensor and the optical system to project the spectrum of the different regions onto the image sensor. An image processor receives the spectrum and analyses it in order to identify cancerous anomalies.

The document WO 02/057426 describes an apparatus for generating a two-dimensional histological map on the basis of a cube of three-dimensional hyper-spectral data representing the scanned image of the neck of the uterus of a patient. It comprises an input processor normalizing the fluorescent spectral signals collected from the cube of hyper-spectral data and extracting the pixels from the spectral signals indicating the classification of the cervical tissues. It also includes a classification device which assigns a tissue category to each pixel, and an image processor connected to the classification device which generates a two-dimensional image of the neck of the uterus on the basis of the pixels including regions coded with the aid of color-coding representing the classifications of the tissues of the neck of the uterus.

The document US 2006/0247514 describes a medical instrument and a method for detecting and evaluating a cancer with the aid of hyper-spectral images. The medical instrument notably comprises a first optical step illuminating the tissue, a spectral separator, one or more polarizers, an image detector, a diagnostic processor and a filter control interface. The method can be used without contact, with the aid of a camera, and allows information to be obtained in real time. It comprises notably a pre-processing of the hyper-spectral information, the construction of a visual image, the definition of a region of interest of the tissue, the conversion of the intensities of the hyper-spectral images into optical density units, and the breakdown of a spectrum for each pixel into a plurality of independent components.

The document US 2003/0030801 describes a method allowing one or more images of an unknown sample to be obtained by illuminating the target sample with a weighted reference spectral distribution for each image. The method analyses the resulting image(s) and identifies the target characteristics. The weighted spectral function generated in this way can be obtained on the basis of a reference image sample and can, for example, be determined by an analysis of its main component, by projection pursuit or by independent component analysis ICA. The method can be used to analyze biological tissue samples.

These documents treat the hyper-spectral images either as collections of images to be processed individually, or by dividing the hyper-spectral cube in order to obtain a spectrum for each pixel, the spectrum then being compared with a reference base. The person skilled in the art will clearly see the shortcomings of these methods, in terms of both methodology and processing speed.

Moreover, one can cite the methods based on the CIEL*a*b representation system and the spectral analysis methods, notably the methods based on reflectance measurement, and those based on absorption spectrum analysis. However, these methods are not adapted to hyper-spectral images and to the quantity of data characterizing them.

It has therefore been noted that the combination of a projection pursuit and a large-margin separation allowed a reliable analysis of hyper-spectral images to be obtained within a calculation time sufficiently short to be industrially applicable.

According to the state of the art, when projection pursuit is used, the partitioning of the data is implemented in constant steps. Thus, for a hyper-spectral cube, the size of the sub-space in which the spectral data are to be projected is chosen, and the cube is then divided in such a way that the same number of bands is present in each group.

This technique has the disadvantage of performing an arbitrary division which does not therefore follow the physical properties of the spectrum. In his thesis manuscript (G. Rellier. Analyse de texture dans l'espace hyper-spectral par des méthodes probabilistes [Texture analysis in the hyper-spectral space using probabilistic methods]. Doctoral Thesis, University of Nice Sophia Antipolis, November 2002.), G. Rellier proposes a variable-step division. Thus, the number of groups of bands is always chosen, but in this case, the boundaries of the groups are chosen in variable steps in order to minimize the variance within each group.

In the same publication, an iterative algorithm is proposed which, on the basis of a constant-step division, minimizes the function Is for each of the groups. This method allows a partitioning to be carried out according to the physical properties of the spectrum, but the choice of the number of groups remains, defined by the user.

This method is not adapted to cases where the images to be processed reveal a wide diversity, or to cases where it is difficult to define the number of groups K, or to cases where the user is not able to measure the number of groups.

A need therefore exists for a method capable of providing a reliable analysis of hyper-spectral images within a sufficiently short calculation time, and capable of automatically reducing a hyper-spectral image into reduced hyper-spectral images before the classing.

### SUMMARY OF THE INVENTION

The subject-matter of the present patent application is a method for analyzing hyper-spectral images.

Another subject-matter of the present patent application is a device for analyzing hyper-spectral images.

Another subject-matter of the present patent application is the application of the analysis device to the analysis of skin lesions.

The device for analyzing a hyper-spectral image comprises at least one sensor able to produce a series of images in at least two wavelengths, a calculation means able to class the pixels of an image according to a two-state classing relation, the image being received from a sensor, and a display means able to display at least one image resulting from the processing of the data received from the calculation means.

The calculation means comprises a means for determining training pixels linked to the two-state classing relation receiving data from a sensor, a means for calculating a projection pursuit receiving data from the means for determining training pixels and being able to effect an automatic division of the spectrum of the hyper-spectral image, and a means for producing a large-margin separation receiving data from the means for calculating a projection pursuit, the calculation means being able to produce data relative to at least one enhanced image in which the pixels obtained following the large-margin separation are distinguishable as a function of their classing according to the two-state classing relation.

The analysis device may comprise a mapping of classed pixels linked to the means for determining training pixels.

The means for calculating a projection pursuit may comprise a first dividing means, a second dividing means and a means for searching for projection vectors.

The means for calculating a projection pursuit may comprise a dividing means with a constant number of bands and a means for searching for projection vectors.

The means for calculating a projection pursuit may comprise a means for shifting the boundaries of each group resulting from the dividing means with a constant number of bands, the shifting means being able to minimize the internal variance of each group.

The means for calculating a projection pursuit may comprise a dividing means with automatic determination of the number of bands as a function of predetermined thresholds, and a means for searching for projection vectors.

The means for determining training pixels may be able to determine the training pixels as the pixels nearest to the thresholds.

The means for producing a large-margin separation may comprise a means for determining a hyperplane, and a means for classing pixels as a function of their distance to the hyperplane.

The calculation means may be able to produce an image that can be displayed by the display means as a function of the hyper-spectral image received from a sensor and the data received from the means for producing a large-margin separation.

According to a different aspect, a method is defined for analyzing a hyper-spectral image originating from at least one sensor able to produce a series of images in at least two wavelengths, comprising a step of acquisition of a hyper-spectral image by a sensor, a step of calculation of the classing of the pixels of a hyper-spectral image received from a sensor according to a two-state classing relation, the display of at least one enhanced image resulting from the processing of the data from the step of acquisition of a hyper-spectral image and the data from the step of calculation of the classing of the pixels of a hyper-spectral image.

The calculation step comprises a step of determination of training pixels linked to the two-state classing relation, a step of calculation of a projection pursuit of the hyper-spectral image comprising the training pixels, comprising an automatic division of the spectrum of said hyper-spectral image, and a large-margin separation step, the calculation step being able to produce at least one enhanced image in which the pixels obtained following the large-margin separation are distinguishable as a function of their classing according to the two-state classing relation.

The step of determination of training pixels may comprise the determination of training pixels as a function of data from a mapping, the step of determination of training pixels furthermore comprising the introduction of said training pixels into the hyper-spectral image received from a sensor.

The step of calculation of a projection pursuit may comprise a first division step relating to the data resulting from the step of determination of training pixels and a step of searching for projection vectors.

The step of calculation of a projection pursuit may comprise a second division step if the distance between two images resulting from the first division step is greater than a first threshold, or if the maximum value of the distance between two images resulting from the first division step is greater than a second threshold.

The step of calculation of a projection pursuit may comprise a division with a constant number of bands.

The boundaries of each group resulting from the division with a constant number of bands can be shifted in order to minimize the internal variance of each group.

The step of calculation of a projection pursuit may comprise a division with automatic determination of the number of bands as a function of predetermined thresholds.

The step of determination of training pixels may comprise a determination of the training pixels as the pixels nearest to the thresholds.

The large-margin separation step may comprise a step of determination of a hyperplane, and a step of classing of the pixels as a function of their distance to the hyperplane, the step of determination of a hyperplane relating to the data resulting from the projection pursuit calculation step.

According to a different aspect, the analysis device is applied to the detection of skin lesions of a human being, the hyperplane being determined as a function of training pixels resulting from previously analyzed templates.

### BRIEF DESCRIPTION OF THE DRAWINGS

Other objects, characteristics and advantages will become apparent from a reading of the following description, given only as a non-limiting example, and provided with reference to the attached figures, in which:

FIG. 1 shows the device for analyzing hyper-spectral images;

FIG. 2 shows the method for analyzing hyper-spectral images; and

FIG. 3 shows the hemoglobin and melanin absorption bands for wavelengths between 300 nm and 1000 nm.

### DETAILED DESCRIPTION OF THE PREFERRED EMBODIMENTS

As indicated above, there are several ways to obtain a hyper-spectral image. However, irrespective of the acquisition method, it is not possible to effect a classing directly on the hyper-spectral image as acquired.

It should be remembered that a hyper-spectral cube is a set of images, each produced at a given wavelength. Each image is two-dimensional, the images being stacked according to a third direction as a function of the variation in the wavelength corresponding to them. Due to the three-dimensional structure obtained, the set is referred to as a hyper-spectral cube. The name hyper-spectral image can also be used to designate the same entity.

A hyper-spectral cube contains a significant quantity of data. However, such cubes contain large spaces that are empty in terms of information and sub-spaces containing a lot of information. The projection of data in a smaller-sized space therefore allows the useful information to be gathered together in a reduced space, causing very little loss of information. This reduction is therefore important for the classification.

It should be remembered that the aim of the classification is to determine, among the set of pixels that make up the hyper-spectral image, those which respond favorably or unfavorably to a two-state classing relation. It is thus possible to determine the parts of a scene presenting a characteristic or a substance.

The first step is to integrate training pixels into the hyper-spectral image. In fact, in order to effect a classification, a so-called supervised method is used. Thus, in order to class the image as a whole, this supervised method consists in using a certain number of pixels associated with a class. These are the training pixels. A class separator is then calculated on these pixels in order to then class the image as a whole.

The training pixels are very few in number compared with the quantity of information that a hyper-spectral image contains. Thus, if a classification is effected directly on the cube of hyper-spectral data with a small number of training pixels, the result of the classification has strong chances of being poor, in accordance with the Hughes phenomenon. It is therefore worth reducing the size of the analyzed hyper-spectral image.

A training pixel corresponds to a pixel whose classing is already known. Therefore, the training pixel is given a class yᵢ=1 or yᵢ=−1 that will serve during the large-margin separation to determine the hyper-spectral plane.

In other words, in an attempt to determine whether a part of an image is relative to water, the classing criterion will be “water”, one distribution will be characteristic of the zones without “water”, another distribution will be characteristic of the zones with “water”, and all zones of the image will be in one or the other of these distributions. In order to initialize the classing method, it will be necessary to present a distribution of training pixels characteristic of a zone with “water”, and a distribution of training pixels characteristic of a zone without “water”. The method will then be able to process all of the other pixels of the hyper-spectral image in order to find the zones with or without “water”. It is also possible to extrapolate the training carried out for one hyper-spectral image to other hyper-spectral images presenting similarities.

The pixels of the hyper-spectral image belong to one of the two possible distributions. One is given the class yᵢ=1 and the other is given the class y₁=−1, according to whether their classing responds positively or not to the two-state classing criterion chosen for the analysis.

The projection pursuit presented here is therefore intended to achieve a reduction of the hyper-spectral cube allowing retention of a maximum amount of information produced by the spectrum then to apply a classification adapted to the context by means of a large-margin separator (LMS).

The projection pursuit is intended to produce a reduced hyper-spectral image comprising projection vectors partitioning the spectrum of the hyper-spectral image. A plurality of partitioning methods can be employed. However, the distance between the training pixels must be optimized in every case. To do this, it is necessary to be able to determine a statistical distance. The index I allows this statistical distance between two distributions of points to be determined. The index I chosen is the Kullback-Leibler index

$$I = {D}_{KL} = \frac{1}{2} {( {μ}_{1} - {μ}_{2} )}^{T} \cdot ( {\sum }_{1}^{- 1} + {\sum }_{2}^{- 1} ) \cdot ( {μ}_{1} - {μ}_{2} ) + tr ( {\sum }_{1}^{- 1} \cdot {\sum }_{2} + {\sum }_{2}^{- 1} \cdot {\sum }_{1} - 2 Id ) \qquad ( Eq . 1 )$$

Where μ₁ and μ₂ are the averages of the two distributions, Σ₁ and Σ₂ are the covariance matrices of the two distributions and

$${\sum }_{12} = \frac{{\sum }_{1} + {\sum }_{2}}{2} ;$$

tr(M) corresponding to the trace of the matrix M, M^{T} corresponding to the transposed matrix M and Id the identity matrix.

The projection pursuit method comprises a partitioning of the spectrum into groups, followed by the determination of a projection vector within each group and the projection of the vectors of the group on the corresponding projection vector.

The partitioning of the spectrum is effected by means of an automatic dividing technique, thanks to a function F_{I} which measures the distance I between consecutive bands. Through analysis of this function F_{I}, the discontinuities of the spectrum in terms of the projection index I are searched for, and these points of discontinuity are thus chosen as the boundaries of the different groups.

The function F_{I} is a discrete function which, for each index k from 1 to Nb−1, where Nb is the number of bands of the spectrum, assumes the value of the distance between two consecutive bands. The discontinuities of the spectrum will therefore appear as being the local maxima of this function F_{I}.

F_{I}(k)=I(image(k),image(k+1)) (Eq. 2)

Where I is the distance, or the index, between two images.

A first step of division of the spectrum is to search for the significant local maxima, i.e. those above a certain threshold. This threshold is then equal to a percentage of the mean value of the function F_{I}. This first division therefore allows a new group to be created for each discontinuity of the spectrum.

However, the analysis of the local maxima is insufficient to effect a division of the spectrum which is both fine and reliable, so the aim of the second step is to analyze the groups resulting from the first division. Interest will therefore be focused on the groups containing an excessive number of bands in order to either divide them into a plurality of groups or keep them as they are.

An example of the necessity of this second step is shown by the example of a hyper-spectral image containing a step of fine spectral sampling. Because of this sampling step, the physical properties between the bands will change slowly. Consequently, the function F_{I} will tend to be lower than the threshold of the first division over a large number of consecutive bands. Bands containing different physical properties therefore risk being present in the same group. It is then necessary to re-divide the groups defined as a result of the first step. Conversely, in the case of a larger sampling step, a re-division of this type is not required. The manner of dividing the groups is known per se to the person skilled in the art.

There are a number of reasons for choosing whether or not to re-divide a group. The initial aim is to recover the information not selected by the first division, by adding a dimension to the projection space each time a group is split into two.

However, one may choose not to divide certain groups into two, so as not to give preference to the information from one zone compared with another, and not to have a division that contains too many groups.

In order to control the second division, a second threshold is defined above which a second division will be carried out.

The division is carried out differently, depending on the behavior of the function F_{I}.

If the function F_{I} is uniform and presents a point where the curve is maximal over the interval considered, the division then takes place at the maximum curve point of the interval, if

I(image(a),image(b))>threshold1.

If the function F_{I} is uniform and linear over the interval considered, the division is then effected in the middle of the interval, if

I(image(a),image(b))>threshold1.

If the function F_{I} is not uniform and does not present a local maximum over the interval considered, the division is then effected in the middle of the interval, if

I(image(a),image(b))>threshold1.

If the function F_{I} is not uniform and presents a local maximum over the interval considered, and if

$${max}_{[ a , b ]} ( I ( image ( a ) , image ( b ) ) ) > threshold 2 ,$$

the division is then effected at the position of this local maximum.

threshold1=mean(F_{I})*C is defined where C is generally equal to two.

threshold2=threshold1*C′ is defined where C′ is generally equal to two thirds.

The first and the second divisions allow a partition of the spectrum into groups to be obtained, each group containing a plurality of images of the hyper-spectral image.

The search for the projection vectors allows the projection vectors to be calculated on the basis of a division of the initial space into sub-groups. To search for the projection vectors, an arbitrary initialization of the projection vectors Vk0 is performed. To do this, within each group k, the vector corresponding to the local maximum of the group is chosen as the projection vector Vk0.

The vector V1 is then calculated, which minimizes a projection index I by maintaining the other vectors constant. Thus, V1 is calculated by maximizing the projection index. The same is then done for the K−1 other vectors. This therefore produces a set of vectors Vk1 where 0<k<K.

The process described above is reiterated until the new calculated vectors no longer change beyond a predetermined threshold.

A projection vector is equivalent to an image of a given wavelength contained in the hyper-spectral image.

Following the projection vector search method, each projection vector can be expressed as being equal to the linear combination of the images contained in the hyper-spectral image adjacent to the projection vector considered.

The set of projection vectors forms the reduced hyper-spectral image.

The use of a large-margin separator (LMS) is proposed to class the pixels of the reduced hyper-spectral image. As illustrated above, a search is carried out within an image for the parts that verify a classing criterion and the parts that do not verify this same classing criterion. A reduced hyper-spectral image corresponds to a space with K dimensions.

A reduced hyper-spectral image is therefore comparable to a cloud of points in a space with K dimensions. The LMS classification method, which consists in separating a cloud of points into two classes, will be applied to this cloud of points. To do this, a hyperplane is searched for which separates the space of the cloud of points into two. The points located on one side of the hyperplane are associated with one class and those located on the other side are associated with the other class.

The LMS method therefore breaks down into two steps. The first step, the training, consists in determining the equation of the separating hyperplane. This calculation requires a certain number of training pixels whose class (yᵢ) is known. The second step is the assignment of a class to each pixel of the image according to its position in relation to the hyperplane calculated during the first step.

The condition for a good classification is therefore to find the optimum hyperplane, in such a way as to separate the two clouds of points in the best possible way. To do this, an attempt is made to optimize the margin between the separating hyperplane and the points of the two training clouds.

Thus, if the margin to be maximized is expressed as

$$\frac{2}{{‖ \vec{ω} ‖}^{2}} ,$$

the equation of the separating hyperplane is expressed as ω.x+b=0, where ω and b are the unknowns to be determined. Finally, by introducing a class (yᵢ=+1 and yᵢ=−1), the search for the separating hyperplane is thus resumed to minimize

$$\frac{{‖ \vec{ω} ‖}^{2}}{2} such that \{ \begin{matrix}\vec{w} \cdot \vec{x} + b \geq + 1 & if {y}_{i} = + 1 \\ \vec{w} \cdot \vec{x} + b \leq - 1 & if {y}_{i} = - 1\end{matrix} \qquad ( Eq . 3 )$$

The problem of optimization of the hyperplane as presented by the equation (Eq. 3) is intractable as such. By introducing the LaGrange polynomials, the dual problem is obtained:

$${max}_{λ} W ( λ ) = - \frac{1}{2} {\sum }_{i = 1}^{N} {λ}_{i} \cdot {λ}_{j} \cdot {\vec{x}}_{i} \cdot {\vec{x}}_{j} + {\sum }_{i = 1}^{N} {λ}_{i} \\ where \\ {\sum }_{i = 1}^{N} {λ}_{i} \cdot {y}_{i} = 0 , {□}_{i} \geq 0 , ∀ i ∈ [ 1 , n ] \qquad ( Eq . 4 )$$

where N is the number of training pixels. The equation (Eq. 4) shows a quadratic optimization problem not specific to the LMSs, and therefore well-known to mathematicians. Various algorithms exist which allow this optimization to be effected.

If there is no linear hyperplane between two classes of pixels, which is often the case when real data are processed, the cloud of points is immersed in a larger space due to a function Φ. In this new space, it then becomes possible to determine a separating hyperplane. The introduced function Φ is a highly complex function. However, if one returns to the optimization equation in the dual space, Φ is not then calculated, but rather the scalar product of Φ at two different points:

$${max}_{λ} W ( λ ) = - \frac{1}{2} {\sum }_{i = 1}^{N} {λ}_{i} \cdot {λ}_{j} \cdot Φ ( {\vec{x}}_{i} ) \cdot Φ ( {\vec{x}}_{j} ) + {\sum }_{i = 1}^{N} {λ}_{i} \\ where \\ {\sum }_{i = 1}^{N} {λ}_{i} \cdot {y}_{i} = 0 , {□}_{i} \geq 0 , ∀ i ∈ [ 1 , n ] \qquad ( Eq . 5 )$$

This scalar product is referred to as the core function and is expressed as K(xᵢ,xⱼ)= [symbol] Φ(xᵢ)|Φ(xⱼ) [symbol] . Numerous core functions can be found in the literature. For our application, we will use a Gaussian core, which is much used in practice, and yields good results.

$$K ( {x}_{i} , {x}_{j} ) = exp ( - \frac{{‖ {\vec{x}}_{i} - {\vec{x}}_{j} ‖}^{2}}{2 \cdot {σ}^{2}} ) \qquad ( Eq . 6 )$$

σ then appears as an adjustment parameter.

During the calculation of the separating hyperplane, for each training pixel, a coefficient λ is calculated (cf. (Eq. 5)). For the majority of the training pixels, this coefficient λ is zero. The training pixels for which λ is non-zero are called support vectors, as these are the pixels that define the separating hyperplane:

$$ω = {\sum }_{i = 1}^{N} {λ}_{i} {y}_{i} Φ ( {\vec{x}}_{i} ) \qquad ( Eq . 7 )$$

When the algorithm runs through the set of training pixels to calculate the λᵢ corresponding to each xᵢ, the parameter σ of the Gaussian core, which corresponds to the width of the Gaussian core, allows the size of the proximity of the pixel xᵢ concerned to be determined, taken into account for the calculation of the corresponding λᵢ.

The unknown b of the hyperplane is then determined by resolving:

λᵢ[yᵢ·(\vec{w}·\vec{x}ᵢ+b)−1]=0 (Eq. 8)

Once the hyperplane is determined, it remains to class the image as a whole as a function of the position of each pixel in relation to the separating hyperplane. To do this, a decision function is used:

$$f ( \vec{x} ) = \vec{w} \cdot \vec{x} + b = {\sum }_{i = 1}^{N} {λ}_{i} \cdot {y}_{i} \cdot Φ ( {\vec{x}}_{i} ) \cdot Φ ( \vec{x} ) + b \qquad ( Eq . 9 )$$

This relation allows the class yᵢ associated with each pixel to be determined as a function of its distance to the hyperplane. The pixels are then considered to be classed.

As the pixels of the reduced hyper-spectral image no longer correspond to the pixels of the hyper-spectral image produced by the sensor, a displayable image cannot easily be reconstituted. However, the spatial coordinates of each pixel of the reduced hyper-spectral image still correspond to the coordinates of the hyper-spectral image produced by the sensor. It is then possible to transpose the classification of the pixels of the reduced hyper-spectral image to the hyper-spectral image produced by the sensor.

The enhanced image presented to the user is then generated by integrating parts of the spectrum in order to determine a computer-displayable image, for example by determining RGB coordinates. If the sensor operates at least in part in the visible spectrum, it is possible to integrate discrete wavelengths in order to determine in a faithful manner the components R, G and B, providing an image close to a photograph.

If the sensor operates outside the visible spectrum, or in a fraction of the visible spectrum, it is possible to determine R, G and B components which will allow a false-color image to be obtained.

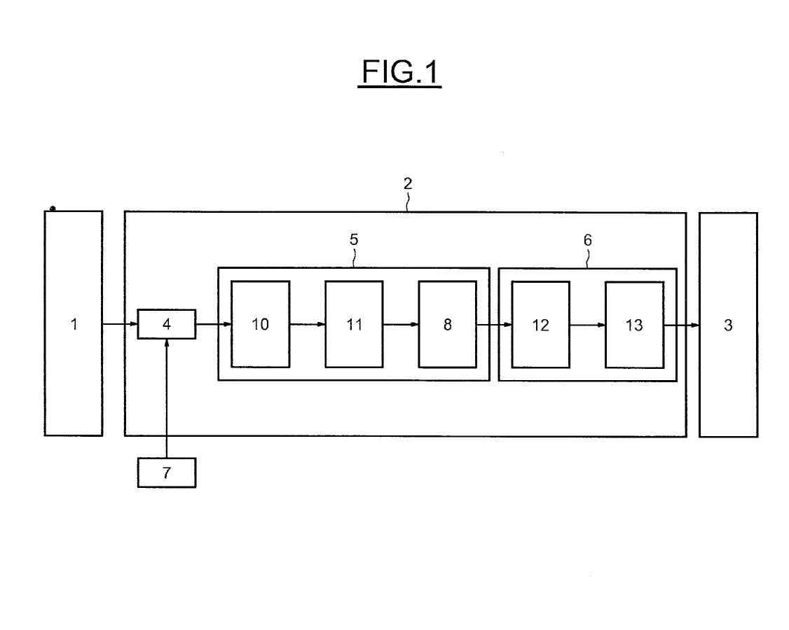

FIG. 1 shows the main elements of a device for analyzing a hyper-spectral image. A hyper-spectral sensor 1, a calculation means 2 and a display device 3 are shown.

The calculation means 2 comprises a means 4 for determining training pixels connected at the input to a hyper-spectral sensor and connected at the output to a means 5 for calculating a projection pursuit.

The means 5 for calculating a projection pursuit is connected at the output to a means 6 for producing a large-margin separation connected in turn at the output to the display device 3. Furthermore, the means 4 for determining training pixels is connected at the input to a mapping 7 of classed pixels.

The means 6 for effecting a large-margin separation comprises a means 12 for determining a hyperplane, and a means 13 for classing pixels as a function of their distance to the hyperplane. The means 12 for determining a hyperplane is connected at the input to the input of the means 6 for effecting a large-margin separation and at the output to the classing means 13 for classing pixels. The means 13 for classing pixels is connected at the output to the output of the means 6 for producing a large-margin separation.

The means 5 for calculating a projection pursuit comprises

a first dividing means 10, itself connected to a second dividing means 11 and a means 8 for searching for projection vectors.

During its operation, the analysis device produces hyper-spectral images thanks to the sensor 1. It will be noted that the sensor 1 is understood to mean a single hyper-spectral sensor, a collection of mono-spectral sensors, or a combination of multi-spectral sensors. The hyper-spectral images are received by the means 4 for determining training pixels which inserts training pixels into each image as a function of a mapping 7 of classed pixels. For these training pixels, the classing information is provided by the value present in the mapping. The pixels of the hyper-spectral image which are not training pixels do not at this stage have any information relating to the classing.

The mapping 7 of classed pixels is understood to mean a set of images similar in form to an image included in a hyper-spectral image, and in which all or part of the pixels is classed into one or the other of the two distributions corresponding to a two-state classing relation.

The hyper-spectral images provided with training pixels are then processed by the means 5 for calculating a projection pursuit.

The first dividing means 10 and the second dividing means 11 included in the means 5 for calculating a projection pursuit will divide the hyper-spectral image according to the direction relative to the spectrum in order to form sets of reduced images, each comprising a part of the spectrum. To do this, the first dividing means 10 applies the equation (Eq. 2). The second dividing means 11 effects a new division of the data received from the first dividing means 10 according to the rules previously described in relation to the values threshold1 and threshold2, otherwise the second dividing means 11 is inactive.

The means 8 for searching for projection vectors included in the means 5 for calculating a projection pursuit arbitrarily initializes the set of projection vectors as a function of the data received from the first dividing means 10 and/or from the second dividing means 11, then determines the coordinates of a projection vector which minimizes the distance I between said projection vector and the other projection vectors by applying the equation (Eq. 1). The same calculation is performed for the other projection vectors. The preceding calculation steps are reiterated until the coordinates of each vector no longer change beyond a predetermined threshold. The reduced hyper-spectral image is then formed from the projection vectors.

The reduced hyper-spectral image is then processed by the means 12 for determining a hyperplane, then by the means 13 for classing pixels as a function of their distance to the hyperplane.

The means 12 for determining a hyperplane applies the equations (Eq. 4) to (Eq. 8) in order to determine the coordinates of the hyperplane.

The means 13 for classing pixels as a function of their distance to the hyperplane applies the equation (Eq. 9). According to the distance to the hyperplane, the pixels are classed and receive the class yᵢ=−1 or yᵢ=+1. In other words, the pixels are classed according to a two-state classing relation, generally the presence or absence of a component or property.

The data comprising the coordinates (x; y) and the class of the pixels are then processed by the display means 3 which is then able to distinguish the pixels according to their class, for example in false colors, or by delimiting the contour delimiting the zones comprising the pixels carrying one or the other of the classes.

In the case of a dermatological application, the hyper-spectral sensors 1 are characteristic of the visible and infrared frequency range. Furthermore, the two-state classing relation can be relative to the presence of skin lesions of a given type, in which case the mapping 7 of classed pixels is relative to these said lesions. According to the embodiment, the mapping 7 is made up of pixels of hyper-spectral images of patient skin analyzed by dermatologists in order to determine the damaged zones. The cartography 7 may comprise only pixels of the classed hyper-spectral image or pixels of other classed hyper-spectral images or a combination of the two. The enhanced image produced corresponds to the image of the patient, superimposed on which the damaged zones are displayed.

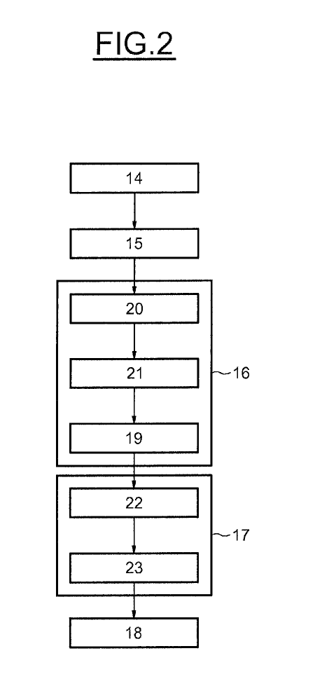

FIG. 2 shows the analysis method and comprises a step 14 of acquiring hyper-spectral images, followed by a step 15 of determining training pixels, followed by a projection pursuit step 16, a step 17 of producing a large-margin separation, and a display step 18.

The step 16 of determining projection vectors comprises successive steps of first division 20, second division 21 and determination 19 of projection vectors.

The step 17 for producing a large-margin separation comprises the successive sub-steps of determination 22 of a hyperplane, and of classing 23 of the pixels as a function of their distance to the hyperplane.

Another example of hyper-spectral image classification concerns the spectral analysis of the skin.

The spectral analysis of the skin is important for dermatologists in order to evaluate the quantities of chromophores in such as way as to quantify diseases. Multi-spectral and hyper-spectral images allow both the spectral properties and the spatial information of a diseased zone to be taken into account. In the literature, it is proposed in a plurality of skin analysis methods to select regions of interest of the spectrum. The disease is then quantified as a function of a small number of bands of the spectrum. It should be remembered that the difference between multi-spectral images and hyper-spectral images lies only in the number of acquisitions effected at different wavelengths. It is generally accepted that a cube of data comprising more than 15 to 20 acquisitions constitutes a hyper-spectral image. Conversely, a cube of data comprising fewer than 15 to 20 acquisitions constitutes a multi-spectral image.

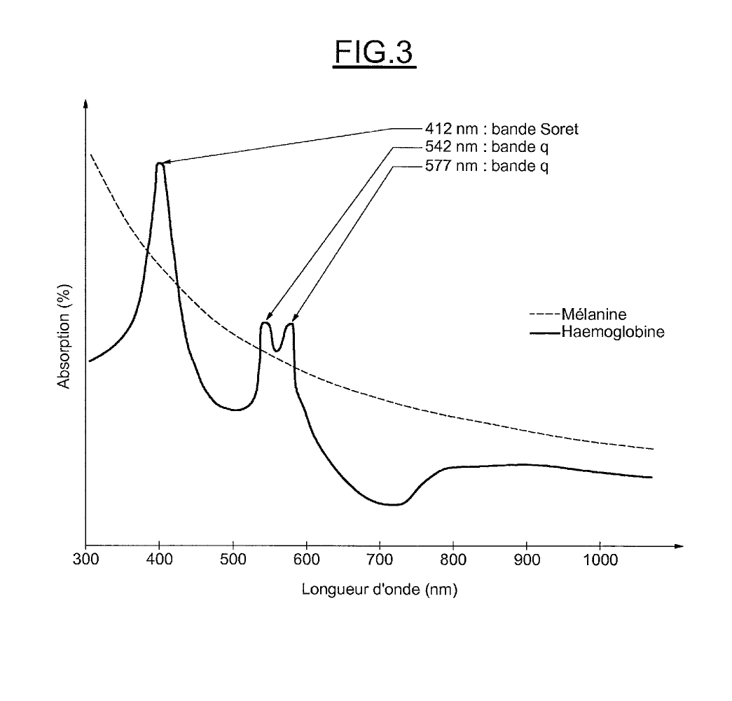

FIG. 3 shows that the q bands and the Soret band of hemoglobin absorption reveal maxima in a zone between 600 nm and 1000 nm, in which the melanin reveals a generally linear absorbance. The main idea of these methods is to evaluate the quantity of hemoglobin using multi-spectral data by compensating for the influence of the melanin in the absorption of the q bands by a band situated around 700 nm in which the absorption of the hemoglobin is low compared with the absorption of the melanin. This compensation is shown by the following equation:

I_{hemoglobin}=−log(I_{q-band}/I₇₀₀) (Eq. 10)

where I_{hemoglobin} is the image obtained, mainly representing the influence of the hemoglobin, I_{q-band} is the image taken in one of the two q bands and I₇₀₀ is the image taken at a wavelength of 700 nm.

In order to extract a mapping which is representative of the melanin, a method has been proposed by G. N. Stamatas, B. Z. Zmudzka, N. Kollias, and J. Z. Beer, in “Non-invasive measurements of skin pigmentation in situ.”, Pigment cell res, vol. 17, pp. 618-626, 2004, which consists in modeling the response of melanin as a linear response between 600 nm and 700 nm.

Aₘ=aλ+b, (Eq. 11)

where

Aₘ: the absorbance of the melanin

λ: the wavelength

a and b: linear coefficients.

In the present approach based on training techniques, the data reduction is used in order to avoid the Hughes phenomenon. The combination of a data reduction and a classification by LMS is known to yield good results.

In the context of the analysis of multi-dimensional data whose variations are linked to physical phenomena, the projection pursuit is used for data reduction. The projection pursuit will be used to merge the data into K groups. The K groups obtained to initialize the projection pursuit may contain a different number of bands. The projection pursuit will then project each group onto a single vector in order to obtain a grayscale image for each group. This is done by maximizing an index I between the projected groups.

Given that a classification between healthy and diseased skin is sought, this index I is maximized between classes in the projected groups, as suggested in the work of L. O. Jimenez and D. A Landgrebe, “Hyperspectral data analysis and supervised feature reduction via projection pursuit,” IEEE Trans. on Geoscience and Remote Sensing, vol. 37, pp. 2653-2667, 1999.

The Kullback-Leibler distance is generally used as the index for projection pursuits. If i and j represent the classes to be discriminated, the Kullback-Leibler distance between the classes i and j can be expressed as follows:

$$\begin{matrix}{D}_{kb} ( i , j ) = \frac{{H}_{kb} ( i , j ) + {H}_{kb} ( j , i )}{2} & ( Eq . 12 ) \\ where & \\ {H}_{kb} ( i , j ) = \int [ {f}_{i} ( x ) \cdot ln \frac{{f}_{i} ( x )}{{f}_{j} ( x )} d x ] & ( Eq . 13 )\end{matrix}$$

and where fᵢ and fⱼ are the distributions of the two classes.

For the Gaussian distributions, the index I and the Kullback-Leibler distance can be expressed as follows:

$$I ( i , j ) = \frac{1}{2} {( {μ}_{i} - {μ}_{j} )}^{T} \cdot ( {\sum }_{i}^{- 1} + {\sum }_{j}^{- 1} ) \cdot ( {μ}_{i} - {μ}_{j} ) … + tr ( {\sum }_{i}^{- 1} \cdot {\sum }_{j} + {\sum }_{j}^{- 1} \cdot {\sum }_{i} - 2 Id ) \qquad ( Eq . 14 )$$

where μ and Σ represent respectively the mean value and the covariance matrix of each class.

In this way, the index I allows the variations between two bands or two groups to be measured. As can be noted, the expression of the index I is a generalization of the preceding equation 1.

The aim of the data reduction is to bring together the redundant information of the bands. The spectrum is divided as a function of the skin absorption variations. The methods of division may differ according to the embodiment. Besides the partitioning method described in relation to the first embodiment, one can cite a non-constant partitioning or a constant partitioning followed by a shifting of the boundaries of each group allowing the internal variance σ_{I}² of each group to be minimized. The internal variance within a group is characterized by the following equation:

$${σ}_{I}^{2} ( k ) = \frac{1}{K} {\sum }_{k = 0}^{K - 1} {I}^{2} ( {z}_{k} , {z}_{k + 1} ) - {( \frac{1}{K} {\sum }_{k = 0}^{K - 1} I ( {z}_{k} , {z}_{k + 1} ) )}^{2} \qquad ( Eq . 15 )$$

where Zₖ is the upper boundary of the kth group.

Thus, by using the projection pursuit for the data reduction and the large-margin separator (LMS) for the classification, different initializations can be used to class the data.

A first initialization is K, the required number of redundant information groups of the spectral bands. A second initialization corresponds to the set of training pixels for the LMS.

Given that skin images reveal different characteristics from one person to another and that the characteristics of the disease may be spread over the spectrum, it is necessary to define two initializations for each image.

In order to remove the constraint relating to the number of groups K, the spectrum is partitioned using a function F_{I}.

F_{I}(k)=I(k−1,k) where k=2, . . . ,Nb (Eq. 16)
where k is the index of the band concerned and Nb is the total number of bands of the spectrum.

Analysis of the function F_{I} makes it possible to determine where the absorption changes of the spectral bands appear. The boundaries of groups are chosen during the partitioning of the spectrum to correspond to the highest local maxima of the function F_{I}. If the variation of the index I along the spectrum is considered as being Gaussian, the mean value and standard deviation of the distribution can be used to determine the most significant local maxima of F_{I}.

Thus, the boundaries of the K spectral groups are the bands corresponding to the maxima of F_{I} up to the threshold T₁ and the minima of F_{I} up to the threshold T₂:

T₁=μ_{F}_{_{I}}+t×σ_{F}_{_{I}} T₂=μ_{F}_{_{I}}−σ_{F}_{_{I}} (Eq. 17)

where μ_{F}_{_{I}} and σ_{F}_{_{I}} are respectively the mean value and the standard deviation of F_{I} and t is a parameter.

The parameter t is chosen once to process the entire set of data. It is preferable to choose a parameter of this type rather than choose the number of groups, as this provides different numbers of groups from one image to the other, which may prove useful in the case of images which have different spectral variations.

This partitioning method can be applied with any given index, such as the Kullback-Leibler correlation or distance.

Introduction of a spatial index into this spectral analysis method allows the LMS to be initialized. In fact, “thresholding” of the spatial index, which will be denoted I_{S}, determined between adjacent bands enables the creation of images mapping the spatial changes from one band to another.

In this application, the hyperpigmentation zones of the skin do not reveal a specific pattern. This is why, in some embodiments, a spatial gradient such as the index I_{S} is determined on a 3×3 square spatial zone denoted υ. In order to extract the spatial information carried by each spectral band, a spatial index Is, defined by the following equation, is used:

$${I}_{S} ( k - 1 , k ) = \frac{1}{N} {\sum }_{i , j ∈ v} \vert S ( i , j , k ) - S ( i , j , k - 1 ) \vert \qquad ( Eq . 18 )$$

where N denotes the number of pixels in the zone υ, κ is the index of the studied band or the projected group and ∀(i, j)εν. S is the intensity of the pixel situated at the spatial position (i,j) and in the spectral band κ. υ is a zone adjacent to the pixel (i,j) of 3×3 pixels.

In fact, the index I_{S}, for each spatial zone of 3×3 pixels, is the mean value of the difference between two bands. A threshold on the index I_{S} allows a binary image to be obtained which represents the spatial variations between two consecutive bands. Thus, a binary image contains a value 1 at the coordinates of a pixel if the intensity of the pixel has changed significantly during the passage from the band k−1 to the band k. The binary image contains a value 0 in the opposite case. The threshold on the spatial index Is therefore represents a parameter allowing the level of change of the values of Is which is considered as significant to be defined. The image which is the most relevant for performing the training of the LMS is then chosen from the binary images obtained. The chosen binary image may be the image providing the global maximum of the function F_{IS} or an image of a zone of interest of the spectrum. In order to optimize the calculation time, it is preferable to choose only a part of a binary image to perform the training of the LMS.

This spatial index may also be used to partition the spectrum. The function F_{IS} is defined in the following form:

F_{I}_{_{S}}(k)=A(I_{S}(k−1,k)) where k=2, . . . ,Nb (Eq. 19)

and where A is the area represented by the pixels for which a change has been detected.

For each binary image obtained from Is(k−1,k) by thresholding, the function F_{IS} in k calculates a real number which is the area of the zone where changes have been detected. Thus, the function F_{IS} and the function F_{I} with a non-spatial index such as the Kullback-Leibler distance (Eq. 12) are homogeneous. The method for analyzing F_{I} described above then allows the boundaries of the spectral groups to be obtained once more.

Finally, the analysis of the spectrum with the function F_{I} and a spatial index I_{S} allows a double initialization in order to obtain an automatic classification process. To summarize, the automatic classification process is as follows:
1. spectral analysis to partition the data into groups for the projection pursuit and extraction of a training set for the LMS
2. projection pursuit to reduce the data, and
3. classification by LMS.

In other words, the analysis method comprises an automatic analysis of the spectrum in such way that the redundant information is reduced and in such a way that the forms of the zones of interest are globally extracted. By using the zones of interest obtained for the training of an LMS applied to the data cube reduced by projection pursuit, a precise classification of the hyperpigmentation of the skin is obtained. The present example is described in relation to the hyperpigmentation of the skin, but it will not escape the person skilled in the art that the hyperpigmentation of the skin is involved in the method described only by way of a variation in color and/or contrast. This method is therefore applicable without modification to other skin pathologies which generate a contrast.

In this case, an index without a priori knowledge is used for the spectral analysis, where the hyperpigmentation zones do not present any particular pattern. If the zones of interest reveal a particular pattern, a spatial index comprising a predetermined form can be used. This is the case, for example, for the detection of blood vessels, where the spatial index then comprises a linear form.

The calculation time for this spectral analysis method is proportional to the number of spectral bands. Nevertheless, as the spatial index I_{S} allows the changes in the local spatial proximities to be estimated, the algorithm corresponding to the method is easily parallelizable.

The instruction of a method for classing multi-spectral images is applicable to hyper-spectral images. In fact, given that the hyper-spectral image is differentiated from the multi-spectral image only by the number of bands, the spaces between the spectral bands are smaller. The changes from one band to another are therefore similarly smaller. A method for spectral analysis of hyper-spectral images comprises a more sensitive detection of changes. It is also possible to improve the detection sensitivity by integrating a plurality of images Is during the processing of hyper-spectral images. An integration of this type allows the spectral changes in the group chosen for the training of the LMS to be merged.

A different embodiment comprises the processing of multi-spectral data, the variations in which are linked to physical phenomena. According to an approach similar to that disclosed above, the processing of multi-spectral data is applicable to the processing of hyper-spectral data, the multi-spectral images and the hyper-spectral images being differentiated only by the number of images acquired at different wavelengths.

The projection pursuit can be used to effect the data reduction. It should be remembered that, according to one embodiment, the projection pursuit algorithms merge the data into K groups containing an equal number of bands, each group then being projected onto a single vector by maximizing the index I between the projected groups. K is then a parameter.

Normally, the number of groups K required for the partitioning of the spectrum is manually defined following an analysis of the classification problem. The data can be partitioned as a function of the absorption variations of the spectrum. Following an initialization with K groups each containing the same number of bands, the boundaries of each group are re-estimated in an iterative manner in order to minimize the internal variance of each group. In order to remove the constraint on the number of groups K, the spectrum is partitioned using the function F_{I}. The spectrum analysis method is used to scan the wavelengths of the spectrum with an index I, such as the internal variance or the Kullback-Leibler distance (Eq. 1). The method thus allows the interesting parts of the spectrum to be inferred from the variations in the index I.

A zone of the spectrum comprising variations is detected if F_{I}(k) exceeds the threshold T1 or passes below the threshold T2. The thresholds T1 and T2 are similar to the previously defined thresholds threshold1 and threshold2. In other words, the partitioning of the spectrum is inferred from the analysis of the function F_{I}. The local extremes of the function F_{I} up to the thresholds T1 and T2 become the boundaries of the groups. Thus, a parameter t defining T1 and T2 (Eq. 17) can be preferred to the parameter K for the partitioning of the spectrum.

The inventors discovered that it was possible to obtain a partitioning of the spectrum without defining a number K, since the bands of interest of the spectrum can be modified as a function of the disease. The spectral analysis with a statistical index does not allow a training set for the classification to be obtained.

A spatial index I_{S} for each voxel proximity may present a spatial mapping of spectral variations. In the present method, the tissues revealing a hyperpigmentation do not reveal a particular texture. It thus appears that the detection is based on the detection of a variation in contrast independent from its underlying cause.

The spectral gradient Is and the function F_{IS} have been previously defined (Eq. 18 and Eq. 19).

F_{IS} is a three-dimensional function. For each pair of bands, the function F_{IS} allows a spatial mapping of spectral variations to be determined. As is evident from the expression of the function F_{IS}, the function A is applied to the function F_{I}. The function A quantifies the pixel change zones, in a manner similar to the function shown by equation 19 relating to the preceding embodiment.

A method allowing a set of training pixels to be extracted from the function F_{IS} will now be described.

The method comprises a projection pursuit for the data reduction. Generally, in order to determine a projection sub-space through projection pursuit, an index I is maximized over the set of projected groups. In the application concerned, a classification of the healthy or pathological tissues is expected. The maximization of the index I between the projected classes is determined. The Kullback-Leibler distance is conventionally used as the projection pursuit index I. The Kullback-Leibler distance can be expressed in the previously described form (Eq. 1).

The projection pursuit is initialized with the partitioning of the spectrum obtained through spectral analysis, then the projection sub-space is determined by maximizing the Kullback-Leibler distance between the two classes defined by the training set.

The training set of the LMS is extracted from the spectral analysis. As previously defined, the LMS is a supervised classification algorithm, notably a two-class classification. An optimal class separator is determined using a training set defining the two classes. Each data point is then classed as a function of its distance with the separator.

It is proposed to use the spectral analysis obtained with the index I to obtain the LMS training set. As described above, the spectral analysis with a spatial index allows a spatial mapping of the spectral changes between two consecutive bands to be obtained. For the training of the LMS, one of these spatial mappings obtained by F_{I}(k) with a spatial index is chosen. The chosen mapping may be the mapping revealing the most changes over the entire spectrum, for example the mapping containing the global extremes of the function F_{IS} over a part of interest or over the entire spectrum.

Once the spatial mapping F_{IS}(k) has been chosen, the N pixels nearest to the thresholds T1 or T2 are extracted for the training of the LMS. One half of the N training pixels is chosen below the threshold and the other half above the threshold.

The method described above was applied to multi-spectral images comprising 18 bands from 405 nm to 970 nm with an average step of 25 nm. These images are around 900×1200 pixels in size. The spectral analysis function F was used in conjunction with the spatial index I_{S} to partition the spectrum. Out of the 18 bands of the data cube concerning both healthy skin tissues and hyperpigmented skin tissues, the spectral analysis yielded a number K equal to 5.

In this example of classification of images of skin affected by hyperpigmentation, the extracted training set comprises the 50 pixels nearest to the threshold T2.

Independently from the example given above, the described method can be applied to hyper-spectral data, i.e. to data comprising many more spectral bands.

The spectral analysis method presented here is adapted to the analysis of multi-spectral images, since the step between spectral bands is sufficient to measure significant variations in the function F_{I}. To adapt this method to the processing of hyper-spectral images, it is necessary to introduce a parameter n into the function F_{I} in such a way as to measure the variations, not between consecutive bands, but between two bands with an offset n. The function F_{I} then becomes:

F_{I}=I_{S}(k−n,k) (Eq. 20)
where k=n+1, . . . , N_{b}

The parameter n can be adapted manually or automatically as a function notably of the number of bands concerned.

1. A device for analyzing a hyper-spectral image, comprising:
at least one sensor able to produce a series of images in at least two wavelengths,
a calculation means able to class the pixels of an image according to a two-state classing relation, the image being received from the sensor and
a display means able to display at least one image resulting from the processing of the data received from the calculation means, wherein the calculation means comprises:
a means for determining training pixels linked to the two-state classing relation receiving data from a sensor,
a means for calculating a projection pursuit receiving data from the means for determining training pixels and being able to effect an automatic division of the spectrum of the hyper-spectral image, and
a means for producing a large-margin separation receiving data from the means for calculating a projection pursuit,
the calculation means being able to produce data relative to at least one enhanced image in which the pixels obtained following the large-margin separation are distinguishable as a function of their classing according to the two-state classing relation.

2. The analysis device as claimed in claim 1, comprising a mapping of classed pixels linked to the means for determining training pixels.

3. The analysis device as claimed in claim 1, in which the means for calculating a projection pursuit comprises a first dividing means, a second dividing means and a means for searching for projection vectors.

4. The analysis device as claimed in claim 1, in which the means for calculating a projection pursuit comprises a dividing means with a constant number of bands and a means for searching for projection vectors.

5. The analysis device as claimed in claim 4, in which the means for calculating a projection pursuit comprises a means for shifting the boundaries of each group resulting from the dividing means with a constant number of bands, the shifting means being able to minimize the internal variance of each group.

6. The analysis device as claimed in claim 1, in which the means for calculating a projection pursuit comprises a dividing means with automatic determination of the number of bands as a function of predetermined thresholds and a means for searching for projection vectors.

7. The analysis device as claimed in claim 6, in which the means for determining training pixels is able to determine the training pixels as the pixels nearest to the thresholds.

8. The analysis device as claimed in claim 1, in which the means for producing a large-margin separation comprises a means for determining a hyperplane, and a means for classing pixels as a function of their distance to the hyperplane.

9. The analysis device as claimed in claim 1, in which the calculation means is able to produce an image that can be displayed by the display means as a function of the hyper-spectral image received from a sensor and the data received from the means for producing a large-margin separation.

10. A method for analyzing a hyper-spectral image originating from at least one sensor able to produce a series of images in at least two wavelengths, comprising:
a step of acquisition of a hyper-spectral image by a sensor,
a step of calculation of the classing of the pixels of a hyper-spectral image received from a sensor according to a two-state classing relation, the display of at least one enhanced image resulting from the processing of the data from the step of acquisition of a hyper-spectral image and the data from the step of calculation of the classing of the pixels of a hyper-spectral image, wherein the calculation step comprises:
a step of determination of training pixels linked to the two-state classing relation,
a step of calculation of a projection pursuit of the hyper-spectral image comprising the training pixels, comprising an automatic division of the spectrum of said hyper-spectral image, and
a large-margin separation step,
the calculation step being able to produce at least one enhanced image in which the pixels obtained following the large-margin separation are distinguishable as a function of their classing according to the two-state classing relation.

11. The analysis method as claimed in claim 10, in which the step of determination of training pixels comprises the determination of training pixels as a function of data from a mapping, the step of determination of training pixels furthermore comprising the introduction of said training pixels into the hyper-spectral image received from a sensor.

12. The analysis method as claimed in claim 11, in which the step of calculation of a projection pursuit comprises a first division step relating to the data resulting from the step of determination of training pixels and a step of searching for projection vectors.

13. The analysis method as claimed in claim 12, in which the step of calculation of a projection pursuit comprises a second division step if the distance between two images resulting from the first division step is greater than a first threshold, or if the maximum value of the distance between two images resulting from the first division step is greater than a second threshold.

14. The analysis method as claimed in claim 10, in which the step of calculation of a projection pursuit comprises a division with a constant number of bands.

15. The analysis method as claimed in claim 14, in which the boundaries of each group resulting from the division with a constant number of bands can be shifted in order to minimize the internal variance of each group.

16. The analysis method as claimed in claim 10, in which the step of calculation of a projection pursuit comprises a division with automatic determination of the number of bands as a function of predetermined thresholds.

17. The analysis device as claimed in claim 16, in which the step of determination of training pixels comprises a determination of the training pixels as the pixels nearest to the thresholds.

18. The analysis method as claimed in claim 10, in which the large-margin separation step comprises a step of determination of a hyperplane, and a step of classing of the pixels as a function of their distance to the hyperplane, the step of determination of a hyperplane relating to the data resulting from the projection pursuit calculation step.

19. An application of an analysis device as claimed in claim 9 to the detection of skin lesions of a human being, the hyperplane being determined as a function of training pixels resulting from previously analyzed templates.
